(19) United States
(12) Patent Application Publication
(10) Pub. No.: US 2014/0182130 A1
(43) Pub. Date: Jul. 3, 2014

(54) ELECTRODE TERMINAL CONNECTOR PRODUCING METHOD

(71) Applicant: HITACHI CABLE, LTD., Tokyo (JP)

(72) Inventors: Takumi SATO, Hitachi (JP); Toshiyuki Horikoshi, Mito (JP); Kotaro Tanaka, Naka-gun (JP); Kenichi Murakami, Hitachi (JP)

(73) Assignee: Hitachi Cable, Ltd., Tokyo (JP)

(21) Appl. No.: 13/871,658

(22) Filed: Apr. 26, 2013

(30) Foreign Application Priority Data
Dec. 28, 2012 (JP) 2012-287848

(51) Int. Cl. H01R 43/16

(52) U.S. Cl. CPC H01R 43/16
USPC 29/882

(57) ABSTRACT

A method is for producing an electrode terminal connector for electrically connecting together a positive and a negative terminal formed of mutually dissimilar metals respectively. The method includes the steps of pressing a thin plate formed of a similar metal to the positive terminal to form a mounting hole in the thin plate, pressing a thick plate formed of a similar metal to the negative terminal to form a metallic member which is smaller in diameter than the mounting hole, and inserting the metallic member into the mounting hole and flattening the metallic member in the mounting hole to widen the mounting hole and join the thin plate and the metallic member together. The steps are continuously performed by a pressing device.

The present application is based on Japanese patent application No. 2012-287848 filed on Dec. 28, 2012, the entire contents of which are incorporated herein by reference.

### BACKGROUND OF THE INVENTION

1. Field of the Invention

The present invention relates to a method for producing an electrode terminal connector for electrically connecting together positive and negative terminals formed of mutually dissimilar metals.

2. Description of the Related Art

In recent years, non-aqueous electrolyte secondary batteries represented by lithium ion secondary batteries have increasingly been put into practical use. The non-aqueous electrolyte secondary batteries have a high energy output per unit volume (or unit mass) in comparison with other batteries such as lead acid batteries and the like, and are therefore expected to be applied to power storage systems utilizing renewable energy for mobile communication devices, laptops, electric vehicles, hybrid vehicles, and solar batteries and the like.

Such non-aqueous electrolyte secondary batteries have an electrode group structured as a stack of positive and negative electrodes with a separator placed therebetween, a case for receiving the electrode group, and an electrolyte solution enclosed in the case.

The positive electrode uses aluminum as its base material, while the negative electrode uses copper as its base material. The positive electrode is electrically connected with a positive terminal made of aluminum or an aluminum alloy, while the negative electrode is electrically connected with a negative terminal made of copper or a copper alloy.

In low-power small-size devices, these non-aqueous electrolyte secondary batteries are used solely, but for large-size devices requiring high power, single-battery power thereof is naturally insufficient and therefore a plurality of non-aqueous electrolyte secondary batteries are connected in series and parallel to produce desired power.

In this case, it is necessary to electrically connect the positive and negative terminals together, and as previously mentioned, the positive and negative terminals are formed of the mutually dissimilar metals respectively, and therefore the dissimilar metals need to be joined together. Joining the dissimilar metals together causes concerns of joint corrosion and resistance increasing due to a local battery effect arising from a difference in ionization tendency between the metals.

Also, for joining per se, resistance welding, which is used as a general way to join the metals together, makes a stable joint strength difficult to achieve, due to a difference between respective melting points of the metals.

For example, JP-A-2011-210482 discloses an electrode terminal connector comprising a positive electrode connecting portion, which is connectable with a positive terminal, and a negative electrode connecting portion, which is connectable with a negative terminal, wherein the positive electrode connecting portion and the negative electrode connecting portion are arranged in such a manner that a perimeter of the positive electrode connecting portion is surrounded by the negative electrode connecting portion, or a perimeter of the negative electrode connecting portion is surrounded by the positive electrode connecting portion, and wherein the positive electrode connecting portion and the negative electrode connecting portion are integrally bonded together by metallic bonding.

Also, JP-A-2012-89254 discloses an electrode terminal connector comprising an electrode joined to one electrode terminal and formed of a similar metal to that electrode terminal, and a bus bar connected to the electrode and formed of a similar metal to the other electrode terminal, wherein the electrode and the bus bar are integral together by diffusion bonding.

These electrode terminal connectors allow the joining of the electrode terminal connector and the electrode terminal to be the joining of the similar metals, therefore, in principle, preventing the occurrence of corrosion and resistance increasing due to the local battery effect, and also permitting the employment of resistance welding or the like as the way to join the metals together.

Refer to JP-A-2011-210482 and JP-A-2012-89254, for example.

### SUMMARY OF THE INVENTION

Now, the electrode terminal connectors disclosed by JP-A-2011-210482 and JP-A-2012-89254 are produced by hydrostatic extrusion to bond the dissimilar metals together to form an intermediate product, followed by cutting of that intermediate product into a plate shape of the electrode terminal connectors.

Achieving the hydrostatic extrusion requires large-scale equipment, and also the cutting of the intermediate product into the plate shape requires a long time and produces chip wastes, therefore being likely to significantly increase production cost.

JP-A-2012-89254 also discloses that the electrode terminal connector is produced by forming a mounting hole in a plate material, followed by a press fit of a metallic member formed of a dissimilar metal into the mounting hole. But, before the press fit of the metallic member into the mounting hole, an oxide film is likely to grow over the surface of the aluminum or aluminum alloy, leading to no sufficient joint strength between the dissimilar metals.

Accordingly, it is an object of the present invention to provide an electrode terminal connector producing method, which requires no large-scale equipment, and which allows a short time from mounting hole formation until metallic member joining, and which can suppress oxide film growth to achieve a sufficient joint strength between dissimilar metals.

(1) According to one embodiment of the invention, a method for producing an electrode terminal connector for electrically connecting together a positive terminal and a negative terminal formed of mutually dissimilar metals respectively comprises the steps of:

pressing a thin plate formed of a similar metal to the positive terminal to form a mounting hole in the thin plate;

pressing a thick plate formed of a similar metal to the negative terminal to form a metallic member which is smaller in diameter than the mounting hole; and

inserting the metallic member into the mounting hole and flattening the metallic member in the mounting hole to widen the mounting hole and join the thin plate and the metallic member together,

in which the steps are continuously performed by a pressing device.

(2) According to another embodiment of the invention, a method for producing an electrode terminal connector for electrically connecting together a positive terminal and a negative terminal formed of mutually dissimilar metals respectively comprises the steps of:

pressing a thin plate formed of a similar metal to the negative terminal to form a mounting hole in the thin plate;

pressing a thick plate formed of a similar metal to the positive terminal to form a metallic member which is smaller in diameter than the mounting hole; and

inserting the metallic member into the mounting hole and flattening the metallic member in the mounting hole to widen the mounting hole and join the thin plate and the metallic member together,

in which the steps are continuously performed by a pressing device.

In one embodiment (1), the following modifications and changes can be made.

(i) The method may further comprise, after joining the thin plate and the metallic member together, heating under an inert atmosphere.

(ii) The method may further comprises pressing the thin plate to form a positive terminal fixing hole therein; and pressing a center region of the metallic member to form a negative terminal fixing hole therein so that the metallic member remains around an inner portion of the mounting hole.

In another embodiment (1), the following modifications and changes can be made.

(i) The method may further comprise, after joining the thin plate and the metallic member together, heating under an inert atmosphere.

(ii) The method may further comprises pressing the thin plate to form a negative terminal fixing hole therein; and pressing a center region of the metallic member to form a positive terminal fixing hole therein so that the metallic member remains around an inner portion of the mounting hole.

### Points of the Invention

According to the embodiments of the invention, it is possible to provide the electrode terminal connector producing method, which requires no large-scale equipment, and which allows a short time from the mounting hole formation until the metallic member joining, and which can suppress oxide film growth to achieve a sufficient joint strength between the dissimilar metals.

### BRIEF DESCRIPTION OF THE DRAWINGS

The preferred embodiments according to the invention will be explained below referring to the drawings, wherein:

FIGS. 1A to 1E are explanatory diagrams showing an electrode terminal connector producing method according to the invention; and

FIG. 2 is a perspective view showing a battery system in which a plurality of non-aqueous electrolyte secondary batteries are connected in series via an electrode terminal connector produced by use of the electrode terminal connector producing method according to the invention.

### DETAILED DESCRIPTION OF THE PREFERRED EMBODIMENTS

Next, preferred embodiments according to the invention will be described in conjunction with the accompanying drawings.

### First Embodiment

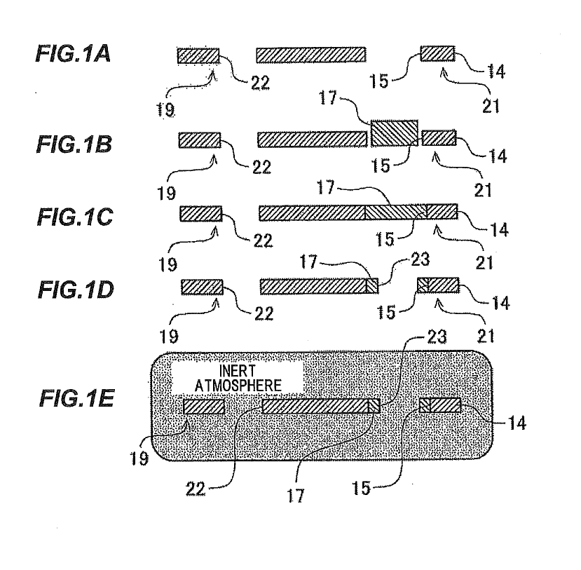

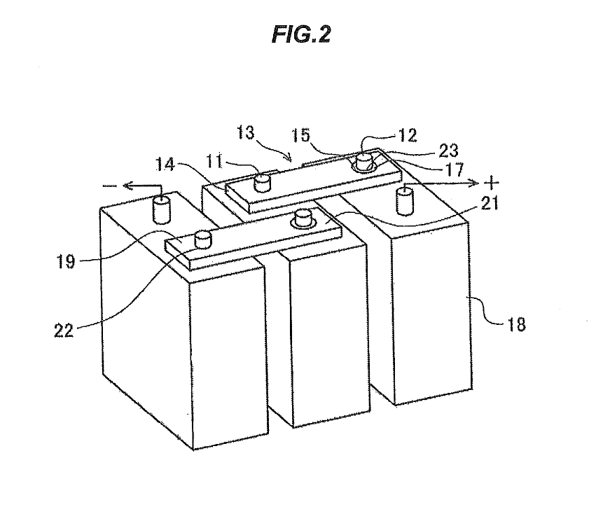

As shown in FIGS. 1A to 1E and 2, an electrode terminal connector producing method in this embodiment is a method for producing an electrode terminal connector 13 for electrically connecting together a positive terminal 11 and a negative terminal 12 formed of mutually dissimilar metals. The method comprises the steps of: pressing a thin plate 14 formed of a similar metal to the positive terminal 11 to form a mounting hole 15 in the thin plate 14; pressing a thick plate (not shown) formed of a similar metal to the negative terminal 12 to form a metallic member 17 which is smaller in diameter than the mounting hole 15; and inserting the metallic member 17 into the mounting hole 15 and flattening (e.g. crushing) the metallic member 17 in the mounting hole 15 to widen the mounting hole 15 and join the thin plate 14 and the metallic member 17 together, wherein the steps are continuously performed by a pressing device.

The positive terminal 11 and the negative terminal 12 are each provided in such a manner as to extend from a plurality of non-aqueous electrolyte secondary batteries 18. The positive terminal 11 is formed of aluminum or an aluminum alloy, while the negative terminal 12 is formed of copper or a copper alloy.

The plurality of non-aqueous electrolyte secondary batteries 18 are connected in series and parallel via the electrode terminal connector 13 to constitute a battery system to be mounted to power an electric vehicle or hybrid vehicle, for example.

In order to electrically connect together the positive and negative terminals 11 and 12 formed of the mutually dissimilar metals, the electrode terminal connector 13 is equipped with a positive terminal connecting portion 19 to be electrically connected with the positive terminal 11, and a negative terminal connecting portion 21 to be electrically connected with the negative terminal 12.

The positive terminal connecting portion 19 is formed with a positive terminal fixing hole 22 therein for the positive terminal 11 to be inserted therein and fixed by resistance welding or the like, while the negative terminal connecting portion 21 is formed with a negative terminal fixing hole 23 therein for the negative terminal 12 to be inserted therein and fixed by resistance welding or the like.

Here, each of the steps is specifically described.

In the step of pressing the thin plate 14 formed of a similar metal to the positive terminal 11 to form the mounting hole 15 in the thin plate 14, the thin plate 14 formed of aluminum or an aluminum alloy is pressed (especially, punched) to form the mounting hole 15, and form the positive terminal fixing hole 22, resulting in the positive terminal connecting portion 19 (see FIG. 1A). Immediately after this step, no oxide film is formed around an inner surface of the mounting hole 15.

In the step of pressing the thick plate formed of a similar metal to the negative terminal 12 to form the metallic member 17 which is smaller in diameter than the mounting hole 15, the thick plate formed of copper or a copper alloy is pressed (esp. punched) to form the metallic member 17. Since the thick plate is thick in thickness in comparison with the thin plate 14, the thickness of the metallic member 17 is also thicker than the thickness of the thin plate 14.

In the step of inserting the metallic member 17 into the mounting hole 15 and flattening the metallic member 17 in the mounting hole 15 to widen the mounting hole 15 and join the thin plate 14 and the metallic member 17 together, the metallic member 17 is flattened in the mounting hole 15 by punching of the pressing device (see FIGS. 1B and 1C).

At this point, the metallic member 17 is flattened (e.g. crushed) and rolled to increase its diameter to greater than the inner diameter of the mounting hole 15, and thereby widen the mounting hole 15. Consequently, even if an oxide film forms around the inner surface of the mounting hole 15, the oxide film is destroyed immediately before the joining, and new surface creation is furthered, resulting in diffusion bonding of the aluminum or aluminum alloy of the mounting hole 15 and the copper or copper alloy of the metallic member 17.

This results in joining together of the dissimilar metals, aluminum or aluminum alloy of the mounting hole 15 and copper or copper alloy of the metallic member 17. This joining is the diffusion bonding with the two different metal surfaces metallurgically integral together in a solid phase state, therefore allowing enhancement of joining reliability and prevention of corrosion and resistance increasing due to the local battery effect.

Because the pressing process is fast in comparison with other working methods, continuously performing these steps with the pressing device allows minimizing oxide film growth, while at the same time, furthering new surface creation to achieve a sufficient joint strength between the dissimilar metals.

Incidentally, in order to continuously perform these steps with the pressing device, for example, the steps may be separated for each working stage (base frame), and each working stage may be switched with the progress of the steps with a conveyor.

The steps are followed by pressing (especially, punching) of the metallic member 17 joined into the mounting hole 14 to form the negative terminal fixing hole 23. It results in the negative terminal connecting portion 21 (see FIG. 1D).

At this point, the negative terminal fixing hole 23 is formed in a center region of the metallic member 17, so that the metallic member 17 remains around the inner portion of the mounting hole 15. This allows the negative terminal 12 and the metallic member 17 which are the mutually similar metals to be contacted and joined together.

Also, the electrode terminal connector producing method in this embodiment preferably further comprises the step of after joining the thin plate 14 and the metallic member 17 together, heating under an inert atmosphere (see FIG. 1E). This allows the diffusion bonding of the aluminum or aluminum alloy of the thin plate 14 and the copper or copper alloy of the metallic member 17 to sufficiently proceed, thereby enhancing the joint strength therebetween.

As the inert atmosphere, a helium gas atmosphere or argon gas atmosphere may be used. Also, the heating temperature is set at a temperature of not higher than melting points of the parent materials, thin plate 14 and metallic member 17.

When the non-aqueous electrolyte secondary batteries 18 are connected in series and parallel via the electrode terminal connector 13 resulting from the steps above, the positive and negative terminals 11 and 12 are electrically connected together by fixing, such as resistance welding or the like, the positive terminal fixing hole 22 of the electrode terminal connector 13 and the positive terminal 11 of one of the non-aqueous electrolyte secondary batteries 18 together, while fixing, such as resistance welding or the like, the negative terminal fixing hole 23 of the electrode terminal connector 13 and the negative terminal 12 of the other of non-aqueous electrolyte secondary batteries 18 together.

At this point, the positive terminal fixing hole 22 contacted with the positive terminal 11 is formed of the thin plate 14 which is the similar metal to the positive terminal 11 and also the inner surface of the negative terminal fixing hole 23 contacted with the negative terminal 12 is covered with the metallic member 17 which is the similar metal to the negative terminal 12. Therefore, the similar metals are joined together, and can, in principle, prevent corrosion and resistance increasing due to the local battery effect.

Also, joining the similar metals together allows for employing convenient resistance welding or the like as the way to join the metals together.

In the electrode terminal connector producing method described so far, the steps from the formation of the mounting hole 15 until the joining of the metallic member 17 are performed by pressing which is excellent in working speed and which can be implemented using small-scale equipment, in comparison with hydrostatic extrusion. Therefore, no large-scale equipment is required, and the time to perform the steps from the formation of the mounting hole 15 until the joining of the metallic member 17 can be shortened.

Also, with the electrode terminal connector producing method, the working speed to perform the steps from the formation of the mounting hole 15 until the joining of the metallic member 17 is fast, in comparison with when hydrostatic extrusion and cutting are used in combination. It is therefore possible to suppress oxide film growth during working.

Further, with the electrode terminal connector producing method, the metallic member 17 is flattened (e.g. crushed) in the mounting hole 15 to widen the mounting hole 15 and join the thin plate 14 and the metallic member 17 together. Therefore, even if an oxide film forms around the inner surface of the mounting hole 15, the oxide film can be destroyed immediately before the joining, and the aluminum or aluminum alloy of the mounting hole 15 and the copper or copper alloy of the metallic member 17 are bonded together by diffusion, thus resulting in a sufficient joint strength between the dissimilar metals, aluminum or aluminum alloy of the thin plate 14 and copper or copper alloy of the metallic member 17.

Incidentally, the invention is not limited to this embodiment, but various modifications may be made without departing from the spirit and scope of the invention.

### Second Embodiment

In the first embodiment the thin plate 14 is formed of aluminum or an aluminum alloy which is the similar metal to the positive terminal 11 while the thick plate is formed of copper or a copper alloy which is the similar metal to the negative terminal 12.

In the second embodiment, the thin plate 14 may be formed of copper or a copper alloy which is the similar metal to the negative terminal 12 while the thick plate may be formed of aluminum or an aluminum alloy which is the similar metal to the positive terminal 11.

Referring again to FIGS. 1A to 1E, 19 may be provided as a negative terminal connecting portion to be electrically connected with the negative terminal 12 and 21 may be provided as a positive terminal connecting portion to be electrically connected with the positive terminal 11. 22 may be provided as a negative terminal fixing hole for the negative terminal 12, while 23 may be provided as a positive terminal fixing hole for the positive terminal 11.

Even in the second embodiment, when the metallic member 17 is flattened in the mounting hole 15 to widen the mounting hole 15 and join the thin plate 14 and the metallic member 17 together, even if an oxide film forms around the surface of the metallic member 17, the oxide film is destroyed by the mounting hole 15 widening, and new surface creation is furthered, resulting in a sufficient joint strength between the dissimilar metals, copper or copper alloy of the thin plate 14 and aluminum or aluminum alloy of the metallic member 17.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A method for producing an electrode terminal connector for electrically connecting together a positive terminal and a negative terminal formed of mutually dissimilar metals respectively, the method comprising the steps of:
pressing a thin plate formed of a similar metal to the positive terminal to form a mounting hole in the thin plate;
pressing a thick plate formed of a similar metal to the negative terminal to form a metallic member which is smaller in diameter than the mounting hole; and
inserting the metallic member into the mounting hole and flattening the metallic member in the mounting hole to widen the mounting hole and join the thin plate and the metallic member together,
wherein the steps are continuously performed by a pressing device.

2. A method for producing an electrode terminal connector for electrically connecting together a positive terminal and a negative terminal formed of mutually dissimilar metals respectively, the method comprising the steps of:
pressing a thin plate formed of a similar metal to the negative terminal to form a mounting hole in the thin plate;
pressing a thick plate formed of a similar metal to the positive terminal to form a metallic member which is smaller in diameter than the mounting hole; and
inserting the metallic member into the mounting hole and flattening the metallic member in the mounting hole to widen the mounting hole and join the thin plate and the metallic member together,
wherein the steps are continuously performed by a pressing device.

3. The method according to claim 1, further comprising:
after joining the thin plate and the metallic member together, heating under an inert atmosphere.

4. The method according to claim 2, further comprising:
after joining the thin plate and the metallic member together, heating under an inert atmosphere.

5. The method according to claim 1, further comprising:
pressing the thin plate to form a positive terminal fixing hole therein; and
pressing a center region of the metallic member to form a negative terminal fixing hole therein such that the metallic member remains around an inner portion of the mounting hole.

6. The method according to claim 2, further comprising:
pressing the thin plate to form a negative terminal fixing hole therein; and
pressing a center region of the metallic member to form a positive terminal fixing hole therein such that the metallic member remains around an inner portion of the mounting hole.
